(19) United States
(12) Patent Application Publication
(10) Pub. No.: US 2025/0390291 A1
(43) Pub. Date: Dec. 25, 2025

(54) ONE SHOT SOFTWARE CODE GENERATION FOR COMMON SOFTWARE MODULES ACROSS VEHICLE CONTROLLERS

(71) Applicant: FCA US LLC, Auburn Hills, MI (US)

(72) Inventors: Naveen Bangalore Rama Krishna, Auburn Hills, MI (US); Sricharan Maruneni, Auburn Hills, MI (US)

(21) Appl. No.: 18/749,709

(22) Filed: Jun. 21, 2024

(51) Int. Cl. G06F 8/61; G06F 8/30; G06Q 10/0875

(52) U.S. Cl. CPC G06F 8/61; G06F 8/30; G06Q 10/0875

(57) ABSTRACT

A software code generation system for a vehicle includes a computing system configured to obtain a build of materials (BOM) for the vehicle, the BOM defining a plurality of software modules for each of a plurality of controllers of the vehicle, modify the BOM to define sets of common software modules and unique software modules, across the plurality of controllers, of the plurality of software modules for each of the plurality of controllers to obtain a modified BOM, receive a user input indicating a request for one shot generation of software code for the set of common software modules, and based on the modified BOM, generating the software code for the set of common software modules via a single processing routine, and an interface configured to load a final software code, based on the generated software code, into the plurality of controllers of the vehicle for future execution.

### FIELD

The present application generally relates to vehicle software code generation and, more particularly, to techniques for one shot software code generation for common software modules across vehicle controllers.

### BACKGROUND

A vehicle includes a plurality of controllers, and each controller typically includes a large number of different software components or modules. Software code generation has thus become a very large part of the vehicle development process. For a vehicle original equipment manufacturer (OEM), there could be a number of variants of software code needed for difference vehicle platforms. For example only, there could be 5 variants and each software code (e.g., ˜200 software components/modules) could take 30+ hours to generate, depending on the processing capability (e.g., number of processor cores). This adds up to over a week of time spent optimizing and generating software code, and this process could take even longer when problems are discovered and redesign is required. In the future, the number of software modules will increase and the number of variants will also likely increase. Accordingly, while such conventional vehicle software code generation systems do work for their intended purpose, there exists an opportunity for improvement in the relevant art.

### SUMMARY

According to one example aspect of the invention, a software code generation system for a vehicle is presented. In one exemplary implementation, the software code generation system comprises a computing system configured to obtain a build of materials (BOM) for the vehicle, the BOM defining a plurality of software modules for each of a plurality of controllers of the vehicle, modify the BOM to define sets of common software modules and unique software modules, across the plurality of controllers, of the plurality of software modules for each of the plurality of controllers to obtain a modified BOM, receive a user input indicating a request for one shot generation of software code for the set of common software modules, and in response to receiving the user input and based on the modified BOM, generating the software code for the set of common software modules via a single processing routine, and an interface configured to load a final software code, based on the generated software code, into the plurality of controllers of the vehicle for future execution.

In some implementations, the computing system is further configured to post-process the generated software code to obtain and save processed software code. In some implementations, the computing system is configured to save the processed software code in a respective one or more code generation folders. In some implementations, the processed software code and any other generated software code for the plurality of controllers are gathered to collectively form the final software code.

In some implementations, the modified BOM is a spreadsheet-type file that includes an additional column including additional information defining the sets of common and unique software modules. In some implementations, the user input further indicates a number of processors or processing cores of a processor of the computing system to be utilized in the single processing routine. In some implementations, the user input indicates (i) one processor or processing core of the processor, (ii) two processors or processing cores of the processor, or (iii) four processors or processing cores of the processor.

According to another example aspect of the invention, a software code generation method for a vehicle is presented. In one exemplary implementation, the software code generation method comprises obtaining, by a computing system, a BOM for the vehicle, the BOM defining a plurality of software modules for each of a plurality of controllers of the vehicle, modifying, by the computing system, the BOM to define sets of common software modules and unique software modules, across the plurality of controllers, of the plurality of software modules for each of the plurality of controllers to obtain a modified BOM, receiving, by the computing system, a user input indicating a request for one shot generation of software code for the set of common software modules, in response to receiving the user input and based on the modified BOM, generating, by the computing system, the software code for the set of common software modules via a single processing routine, and loading, by the computing system and via an interface, a final software code, based on the generated software code, into the plurality of controllers of the vehicle for future execution.

In some implementations, the software code generation method further comprises post-processing, by the computing system, the generated software code to obtain and save processed software code. In some implementations, the saving of the processed software code is in a respective one or more code generation folders. In some implementations, the processed software code and any other generated software code for the plurality of controllers are gathered to collectively form the final software code.

In some implementations, the modified BOM is a spreadsheet-type file that includes an additional column including additional information defining the sets of common and unique software modules. In some implementations, the user input further indicates a number of processors or processing cores of a processor of the computing system to be utilized in the single processing routine. In some implementations, the user input indicates (i) one processor or processing core of the processor, (ii) two processors or processing cores of the processor, or (iii) four processors or processing cores of the processor.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a plurality of controllers configured to execute software code generated by a software code generation system according to the principles of the present application;

FIG. 2A is a functional block diagram of an example software code generation system for generating software code for vehicle controllers according to the principles of the present application;

FIG. 2B is an example graphical user interface (GUI) for the software code generation system according to the principles of the present application; and

FIG. 3 is a flow diagram of an example one shot software code generation method for common software modules of a vehicle and its controllers according to the principles of the present application.

### DESCRIPTION

As previously discussed, vehicles include a plurality of controllers and each controller typically includes a large number of different software components or modules, and thus software code generation has become a very large part of the vehicle development process. For a vehicle original equipment manufacturer (OEM), there could be a number of variants of software code needed for difference vehicle platforms. For example only, there could be 5 variants and each software code (e.g., ˜200 software components/modules) could take 30+ hours to generate, depending on the processing capability (e.g., number of processor cores). This adds up to ˜8-9 days of time spent optimizing and generating software code, and this process could take even longer when problems are discovered and redesign is required. In the future, the number of software modules will increase and the number of variants will also likely increase. Accordingly, improved software code generation systems and methods for vehicles are presented herein.

These systems and methods leverage the fact that many software modules are common across different vehicle platforms. Non-limiting examples of software modules include a motor torque control module and an engine torque control module. The software code generation techniques are implemented as an offline software tool that is utilized during vehicle development. A build of materials (BOM) for each vehicle and its controllers is updated/modified with an extra column that contains additional information through which the tool segregates common and unique software modules. The tool allows for selection of a “one shot” code generation option that generates the software code for all of the common software modules and, after post-processing to obtain processed software code, copies the processed software code into the applicable code generation folder(s). According to the Inventors, the potential benefit for a future plan of 16+ variants could be ˜125 hours (i.e., a week of development).

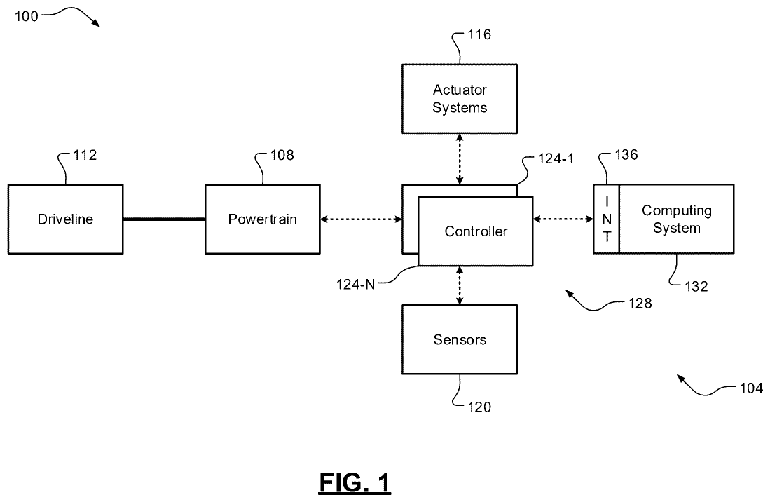

Referring now to FIG. 1, a functional block diagram of a vehicle 100 having an example software code generation system 104 according to the principles of the present application is illustrated. The vehicle 100 generally includes a powertrain 108 configured to generate and transfer drive torque to a driveline 112 for vehicle propulsion. Non-limiting examples of the components of the powertrain 108 include an electric motor, an internal combustion engine, and combinations thereof, and a gear reducer or transmission. The vehicle 100 also includes a plurality of actuator systems 116 and a plurality of sensors 120 that are interface with by a plurality of controllers 124-1 . . . 124-N (N being an integer greater than one; collectively, “controllers 124”) via a controller area network (CAN) 128 to control operation of the vehicle 100 including different functionalities (motor torque management, engine torque management, etc.). The controllers 124 and the CAN 128 could be arranged, for example, according to the AUTomotive Open System ARchitecture (AUTOSAR®) standard. A computing system 132 is configured to generate the software code according to the techniques of the present application and upload the final software code to the controllers 124 via an interface (INT) 136.

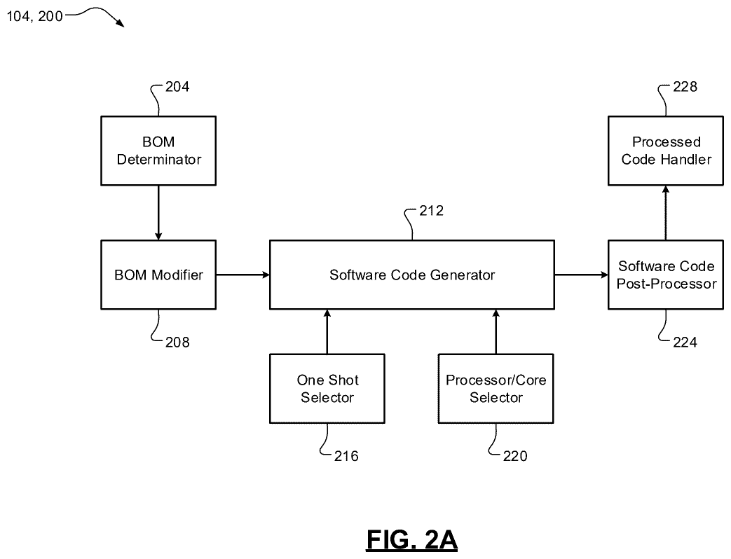

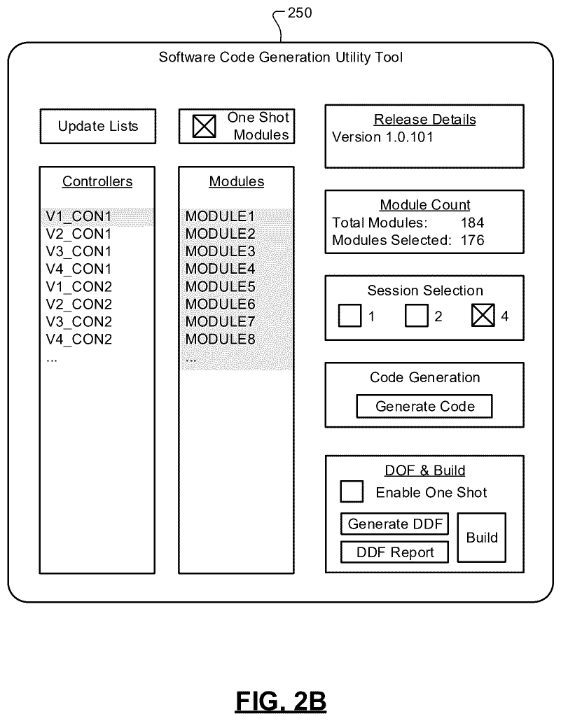

Referring now to FIG. 2A, a functional block diagram of an example architecture 200 of the software code generation system 104 according to the principles of the present application is illustrated. A BOM determinator block 204 obtains or determines an initial BOM for a particular vehicle having a plurality of controllers (e.g., vehicle 100). This initial BOM represents an unmodified BOM (e.g., a spreadsheet-type file) that lists the various software modules for each particular vehicle controller. This could be, for example, a spreadsheet-type file retrieved from a database or other memory associated with the computing system 132.

The BOM modifier block 208 modifies the initial BOM to include additional information relating to the common and unique software modules across the plurality of controllers. This BOM modifier block 208 could receive a modified BOM based on user input or it could be automatically generated by comparing initial BOMs for different controllers to parse and determine the common and unique sets of software modules. For example only, the BOM modifier block 208 could retrieve a previously-generated or modified BOM from a database or other memory associated with the computing system 132.

The software code generator block 212 uses the modified BOM and different user or operator inputs to generate software code for various software modules. A one shot selector block 216 allows for the user to provide a request for one shot generation of the set of common software modules across the plurality of vehicle controllers. An optional processor/core or session quantity selector 220 allows for the user to specify a number of processors or processor cores of a single processor (1, 2, 4, etc.) to be used during the code generation process. Based on the user inputs and the modified BOM, the software code generator block 212 generates software code either for all of the common software modules or for some combination of unique and/or common software modules as specified by the user. The generated software code is post-processed at post-processor 224 and then the processed software code is handled (e.g., saved in desired folder(s)) by a processed code handler block 228.

Referring now to FIG. 2B and with continued reference to FIG. 2A, an example graphical user interface (GUI, 250) for the software code generation system 104, 200 according to the principles of the present application is illustrated. It will be appreciated that this is merely one example configuration of the GUI for the software generation utility tool for illustrative and descriptive purposes and that other suitable GUIs could be utilized. As shown, the GUI 250 includes a list of controllers for different vehicles/platforms (controller CON1 for vehicles V1-V4, controller CON2 for vehicles V1-V4, etc.) with V1_CON1 being selected by the user. These lists could be periodically updated during development by selecting the update lists button, and the details for the particular version/release can be shown in the release details field. The one shot modules selection option (shown to be selected with an “X”) causes the common software modules of the list of modules to be selected.

As shown, 176 common (one shot) software modules of a total of 184 software modules for the V1_CON1 controller are selected (i.e., all but 8 of the total software modules). This module total/selection is shown to the user in the module count field. In some implementations, the GUI 250 includes a session selection (or processor/core selection) option that allows the user to specify a number of processors or processor cores to be used during the software code generation process.

As shown, 4 processors/cores are selected (4 parallel software code generation sessions), which while taking up more computing resources of the computing system 132, will also cut the overall software code generation time by about 75% compared to a single processor/core. Once all of the options are selected by the user, he/she can select the generate code button to begin the software code execution process, which could take many hours. In some implementations, the GUI 250 also includes a distributed data framework (DDF) control and build field that allows the user to generate/build a DDF (a modular integration framework), and optionally generate a DDF report and/or enable one shot (common) software module selection.

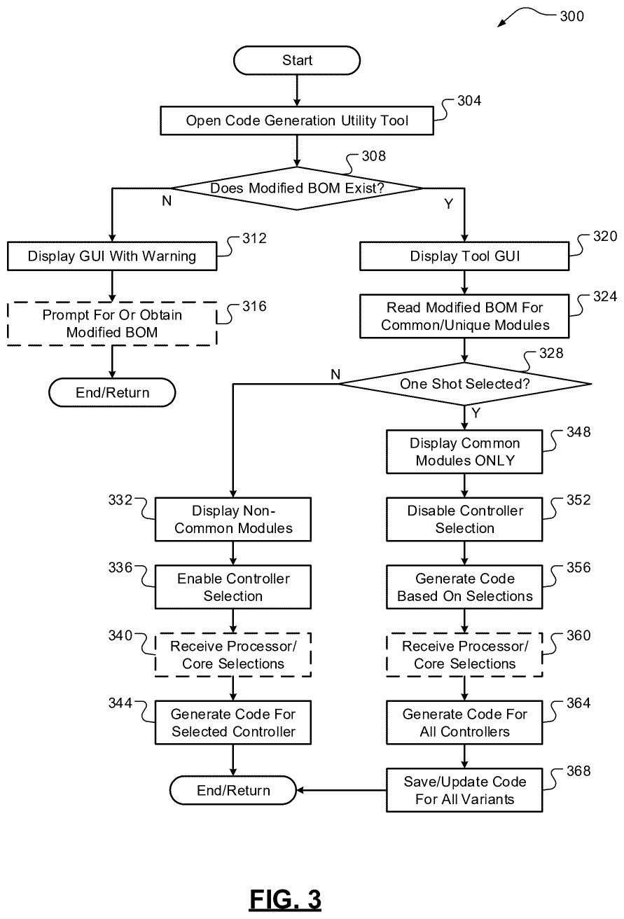

Referring now to FIG. 3, a flow diagram of an example software generation method 300 for a vehicle according to the principles of the present application is illustrated. While the method 300 specifically references the vehicle 100 and architecture 200 and their respective sub-components for illustrative and descriptive purposes, it will be appreciated that the method 300 could be applicable to any suitably configured computing system and vehicle. The method 300 begins at 304. At 304, the computing system 132 starts or initializes the software code generation system utility tool. At 308, the computing system 132 determines whether the modified BOM exists. When false, the method 300 proceeds to 312. When true, the method 300 proceeds to 320. At 312, the computing system 132 displays a GUI with a user warning that the modified BOM does not exist. At optional 316, the computing system 132 could prompt the user to provide the modified BOM or modify an initial BOM to obtain the modified BOM, or this could be performed automatically by the computing system 132 (e.g., by comparison and parsing to determine the common/unique software modules). The method 300 then ends or returns to 308.

At 320, the computing system 132 displays the GUI (e.g., GUI 250) for the software code generation utility tool. At 324, the computing system 132 reads the modified BOM to determine the common/unique software modules. At 328, the computing system 132 determines whether the one shot option is selected or enabled. When false, the method 300 proceeds to 332. When true, the method 300 proceeds to 348. At 332, the computing system 132 displays the non-common (unique) software modules and, at 336, the computing system 132 enables selection of a particular vehicle controller (V1_CON1, V1_CON2, etc.). At optional 340, the computing system 132 receives user input specifying a number of sessions for the software code generation process. At 344, the computing system 132 generates the code for the selected modules (unique, common, or some combination thereof) for the selected controller (e.g., V1_CON1). The method 300 then ends or returns to 304/308 for one or more additional cycles.

At 348, the computing system 132 displays only the common software modules (e.g., see FIG. 2B) and, at 352, the computing system 132 disables the vehicle controller selection since one shot (common) software module code generation has been selected. At 356, the computing system 132 could initiate the software code generation for the particular user selections. However, at optional 260, the computing system 132 could receive session selection input from the user specifying a number of parallel sessions for the software code generation process (1, 2, 4, etc.).

When received, at 364, the computing system 132 generates the software code according to the user selections including the specified number of sessions. At 368, the computing system 132 (e.g., after post-processing the generated software code) saves the processed software code in the desired folder(s) and can also update the final software code across multiple variants (i.e., vehicles/platforms) having common vehicle software modules. This could include, for example, updating an AUTOSAR extensible markup language (XML), or AUTOSAR XML (.ASXML) file. The method 300 then ends or returns to 304/308 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture or single or multiple processor cores operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A software code generation system for a vehicle, the software code generation system comprising:
a computing system configured to:
obtain a build of materials (BOM) for the vehicle, the BOM defining a plurality of software modules for each of a plurality of controllers of the vehicle,
modify the BOM to define sets of common software modules and unique software modules, across the plurality of controllers, of the plurality of software modules for each of the plurality of controllers to obtain a modified BOM,
receive a user input indicating a request for one shot generation of software code for the set of common software modules, and
in response to receiving the user input and based on the modified BOM, generate the software code for the set of common software modules via a single processing routine; and
an interface configured to load a final software code, based on the generated software code, into the plurality of controllers of the vehicle for future execution.

2. The software code generation system of claim 1, wherein the computing system is further configured to post-process the generated software code to obtain and save processed software code.

3. The software code generation system of claim 2, wherein the computing system is configured to save the processed software code in a respective one or more code generation folders.

4. The software code generation system of claim 3, wherein the processed software code and any other generated software code for the plurality of controllers are gathered to collectively form the final software code.

5. The software code generation system of claim 1, wherein the modified BOM is a spreadsheet-type file that includes an additional column including additional information defining the sets of common and unique software modules.

6. The software code generation system of claim 1, wherein the user input further indicates a number of processors or processing cores of a processor of the computing system to be utilized in the single processing routine.

7. The software code generation system of claim 6, wherein the user input indicates (i) one processor or processing core of the processor, (ii) two processors or processing cores of the processor, or (iii) four processors or processing cores of the processor.

8. A software code generation method for a vehicle, the software code generation method comprising:
obtaining, by a computing system, a build of materials (BOM) for the vehicle, the BOM defining a plurality of software modules for each of a plurality of controllers of the vehicle;
modifying, by the computing system, the BOM to define sets of common software modules and unique software modules, across the plurality of controllers, of the plurality of software modules for each of the plurality of controllers to obtain a modified BOM;
receiving, by the computing system, a user input indicating a request for one shot generation of software code for the set of common software modules;
in response to receiving the user input and based on the modified BOM, generating, by the computing system, the software code for the set of common software modules via a single processing routine; and
loading, by the computing system and via an interface, a final software code, based on the generated software code, into the plurality of controllers of the vehicle for future execution.

9. The software code generation method of claim 8, further comprising post-processing, by the computing system, the generated software code to obtain and save processed software code.

10. The software code generation method of claim 9, wherein the saving of the processed software code is in a respective one or more code generation folders.

11. The software code generation method of claim 10, wherein the processed software code and any other generated software code for the plurality of controllers are gathered to collectively form the final software code.

12. The software code generation method of claim 8, wherein the modified BOM is a spreadsheet-type file that includes an additional column including additional information defining the sets of common and unique software modules.

13. The software code generation method of claim 8, wherein the user input further indicates a number of processors or processing cores of a processor of the computing system to be utilized in the single processing routine.

14. The software code generation method of claim 13, wherein the user input indicates (i) one processor or processing core of the processor, (ii) two processors or processing cores of the processor, or (iii) four processors or processing cores of the processor.
